(19) United States
(12) Patent Application Publication
(10) Pub. No.: US 2026/0084859 A1
(43) Pub. Date: Mar. 26, 2026

(54) GENERATOR PACKAGING FRAME

(71) Applicant: Chongqing Hudson New Energy Co., Ltd., Chongqing (CN)

(72) Inventors: Yujing Jiang, Chongqing (CN); Hui Yang, Chongqing (CN); Sheng Li, Chongqing (CN)

(21) Appl. No.: 19/337,124

(22) Filed: Sep. 23, 2025

(30) Foreign Application Priority Data
Sep. 23, 2024 (CN) 202422325271.6

(51) Int. Cl. B65D 6/08; B65D 85/68; F16M 3/00

(52) U.S. Cl. CPC B65D 7/14; B65D 85/68; F16M 3/00; B65D 2585/6877

(57) ABSTRACT

A generator packaging frame comprises a lower frame, an upper frame, a plurality of first supporting arms and a plurality of second supporting arms. The plurality of first supporting arms can be respectively and detachably connected with the lower and the upper frames. Each second supporting arm detachably arranged on each first supporting arm. The plurality of second supporting arms can also be respectively and detachably connected with the lower and the upper frames. The distance between the lower frame and the upper frame when the first support arm connects to them is larger than the distance between those frames when the second support arm connects to them. The packaging frame has two structural forms. It can be used for packaging and transportation of the generator and also can be used as a supporting seat of the generator after being reassembled.

### TECHNICAL FIELD

The instant disclosure is related to the technical field of conveying devices, in particular to a generator packaging frame.

### BACKGROUND

A gas generator uses natural gas or harmful gas as fuel and has the advantages of wide range of output power, high starting and running reliability, high quality of power generation, light weight, small volume, easy maintenance, low frequency noise etc. The gas generator has very broad market prospects.

When the gas generator leaves the factory, the gas generator is generally required to be placed in a packaging frame for transportation, and the packaging frame can provide protection for the generator. The packing frame usually adopts a wooden or steel structure, but the self-structure of wooden frame has low strength to protect the generator and can only be used as a single-use or disposable product. Therefore, the wooden packing frame is gradually replaced by the steel packing frame.

The current steel packaging frame improves the protection to transport the generator, but it can only be used as a package due to single function, and it is inevitably treated as waste after disassembling by customers, which causes the waste of materials.

### SUMMARY

The invention aims to provide a generator packaging frame so as to improve the functionality of the packaging frame and avoid the waste of materials due to the defects in the prior art,

The invention provides a generator packing frame, comprising a lower frame, an upper frame, a plurality of first support arms, and a plurality of second support arms, wherein the first support arms can be respectively and detachably connected with the lower frame and the upper frame;

When the first support arm is connected with the lower frame and the upper frame, the distance between the lower frame and the upper frame is denoted as L1, and when the second support arm is connected with the lower frame and the upper frame, the distance between the lower frame and the upper frame is denoted as L2, and L2 is smaller than L1.

Preferably, the first support arm is vertically provided with two first connecting portions. The second support arm is vertically provided with two second connecting portions. The lower frame is provided with a plurality of third connecting portions, and the upper frame is provided with a plurality of fourth connecting portions. The first connecting portions can be detachably connected with the third connecting portions and the fourth connecting portions respectively, and the second connecting portions can be detachably connected with the third connecting portions and the fourth connecting portions respectively.

Preferably, the first support arm is vertically provided with two fifth connection portions, and the fifth connection portions are detachably connected with the second connection portions.

Preferably, the lower frame can securely stack the top of the upper frame.

Preferably, when the first support arm is connected with the upper frame, the first support arm extends out of the top surface of the upper frame and forms a first limit part. Additionally, when the second support arm is connected with the upper frame, the second support arm extends out of the top surface of the upper frame and forms a second limit part.

Preferably, the four corners of the lower frame are respectively provided with supporting feet. The supporting feet extend below the invention, and the supporting feet can be stacked on the top surface of the upper frame.

Preferably, the upper frame is provided with at least two connecting blocks. A sixth connecting part is arranged on the connecting blocks, and the lower frame is provided with a seventh connecting part matched with the sixth connecting part.

Preferably, the first support arm is provided with a flange. The flange is located between the two first connecting parts, and the flange is respectively abutted against the upper frame and the lower frame.

Preferably, the device further comprises a plurality of connecting arms, and each connecting arm can be detachably connected with the upper frame and the lower frame respectively.

The invention has a multitude of beneficial effects. According to the generator packaging frame disclosed by the invention, the second supporting arm with a shorter design length is used for connecting the lower frame and the upper frame after the first supporting arm is disassembled, so that the overall height of the packaging frame can be reduced. Therefore, the packaging frame can be used as a supporting seat for supporting a generator, and the stability of the generator in the running process is improved. The packaging frame has two structural forms, can be used for packaging and transportation of the generator, can be used as a supporting seat of the generator after being reassembled, improves the stability of the generator in the operation process, avoids the waste of materials, and has the advantages of novel structure, various purposes and convenient disassembly and assembly.

### DESCRIPTION OF THE DRAWINGS

In order to more clearly illustrate the embodiments of the present invention or the technical solutions in the prior art, the drawings used in the description of the embodiments or the prior art will be briefly described below. Similar elements or portions are generally identified by similar reference numerals throughout the figures. The drawings, elements or portions thereof are not necessarily drawn to scale.

FIG. 1 is a schematic view of a structure of a generator package frame according to an embodiment of the present invention;

FIG. 2 is a schematic view of another form of the package shelf;

FIG. 3 is a schematic view of the first support arm and the second support arm in cooperation;

FIG. 4 is an exploded view of the FIG. 3 state;

FIG. 5 is a schematic view of the structure of the flange;

FIG. 6 is a top view of the first support arm;

FIG. 7 is a schematic view of a stack of two packaging frames;

FIG. 8 is a partial schematic view of FIG. 7 at A;

FIG. 9 is a partial schematic view of FIG. 7 at B;

### REFERENCE NUMERALS

10 is the device comprises a lower frame, 11 is supporting legs, 20 is an upper frame, 30 is a first supporting arm, 31 is a first connecting part, 32 is a fifth connecting part, 33 is a flanging, 34 is a first limiting part, 40 is a second supporting arm, 41 is a second connecting part, 42 is a second limiting part, 50 is a connecting block, 51 is a sixth connecting part, and 60 is a connecting arm.

### DETAILED DESCRIPTION OF THE INVENTION

Embodiments of the technical scheme of the present invention will be described in detail below with reference to the accompanying drawings. The following examples are only for more clearly illustrating the technical aspects of the present invention, and thus are merely examples, and are not intended to limit the scope of the present invention.

It is noted that unless otherwise indicated, technical or scientific terms used herein should be given the ordinary meaning as understood by one of ordinary skill in the art to which this invention belongs.

In the description of the present invention, it should be understood that the terms “center”, “longitudinal”, “lateral”, “length”, “width”, “thickness”, “upper”, “lower”, “front”, “rear”, “left”, “right”, “vertical”, “horizontal”, “top”, “bottom”, “inner”, “outer”, “clockwise”, “counterclockwise”, “axial”, “radial”, “circumferential”, etc. indicate orientations or positional relationships based on the orientations or positional relationships shown in the drawings are merely for convenience in describing the present invention and simplifying the description, and do not indicate or imply that the device or element being referred to must have a specific orientation, be configured and operated in a specific orientation, and therefore should not be construed as limiting the present invention.

Furthermore, the terms “first,” “second,” and the like, are used for descriptive purposes only and are not to be construed as indicating or implying a relative importance or implicitly indicating the number of technical features indicated. In the description of the present invention, the meaning of “plurality” is two or more unless specifically defined otherwise.

In the present invention, unless explicitly specified and limited otherwise, the terms “mounted,” “connected,” “secured,” and the like are to be construed broadly, and may be, for example, fixedly connected, detachably connected, or integrally formed, mechanically connected, electrically connected, directly connected, indirectly connected via an intervening medium, or in communication between two elements or in an interaction relationship between two elements. The specific meaning of the above terms in the present invention can be understood by those of ordinary skill in the art according to the specific circumstances.

In the present application, unless expressly stated or limited otherwise, the description that a first element is “above” or “below” a second element may either be the first and second elements in direct contact, or the first and second elements are in indirect contact via an intervening medium. Moreover, a first element being “above,” “over” and “on” a second element may either be a first element being directly above or obliquely above the second element, or simply indicating that the first element is on a higher plane than the second element. The first element being “under”, “below” and “beneath” the second element may either be the first element being directly under or obliquely below the second element, or simply indicating that the first element is at a lower level than the second element.

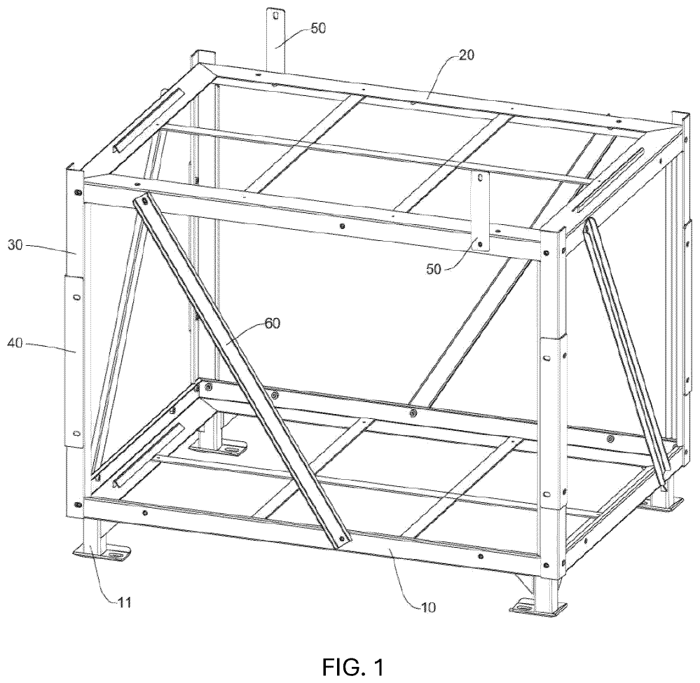

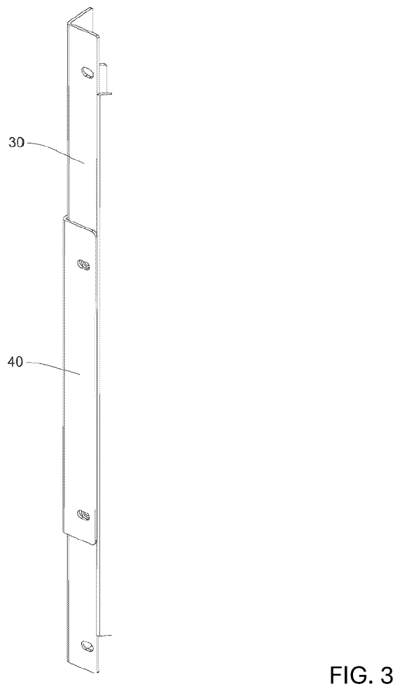

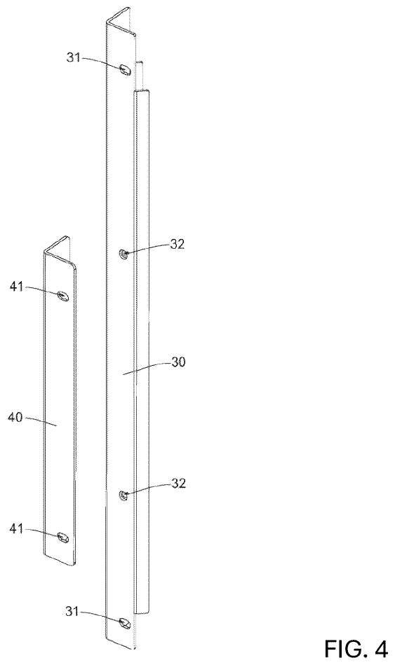

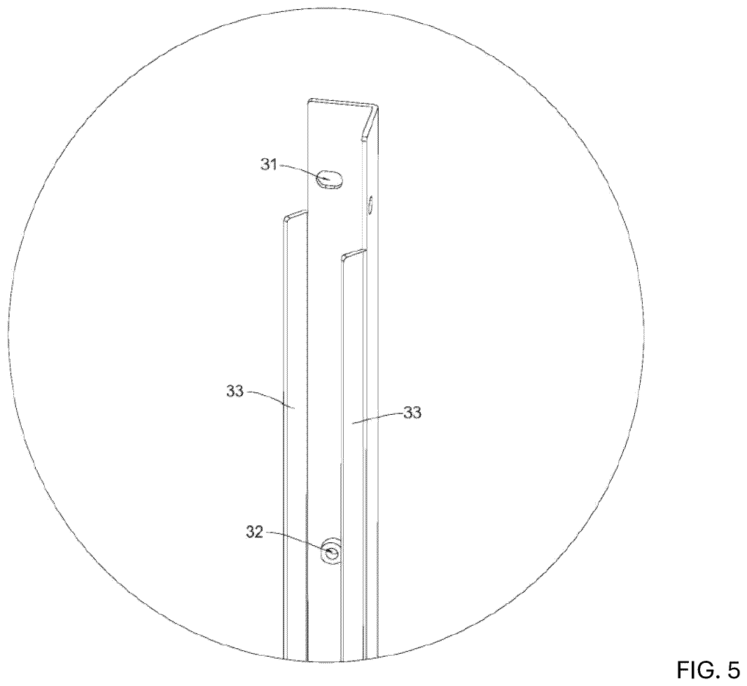

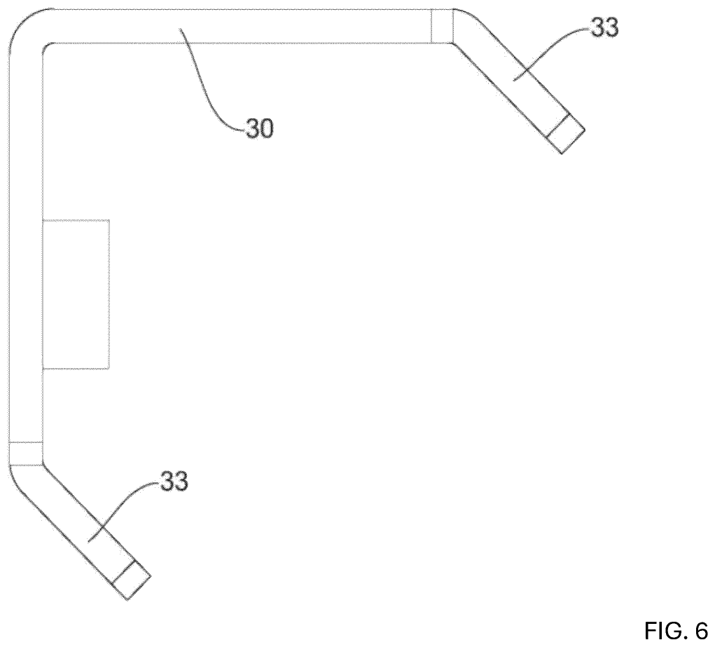

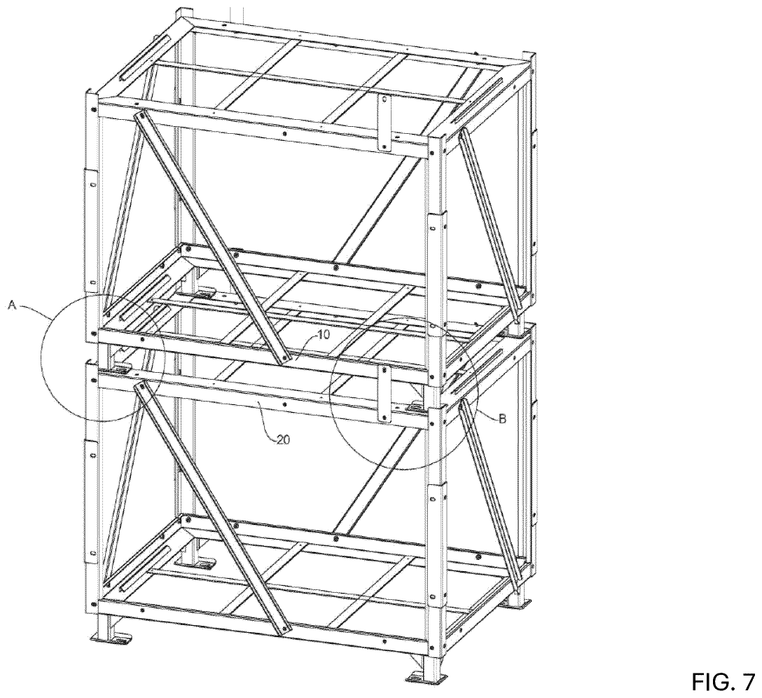

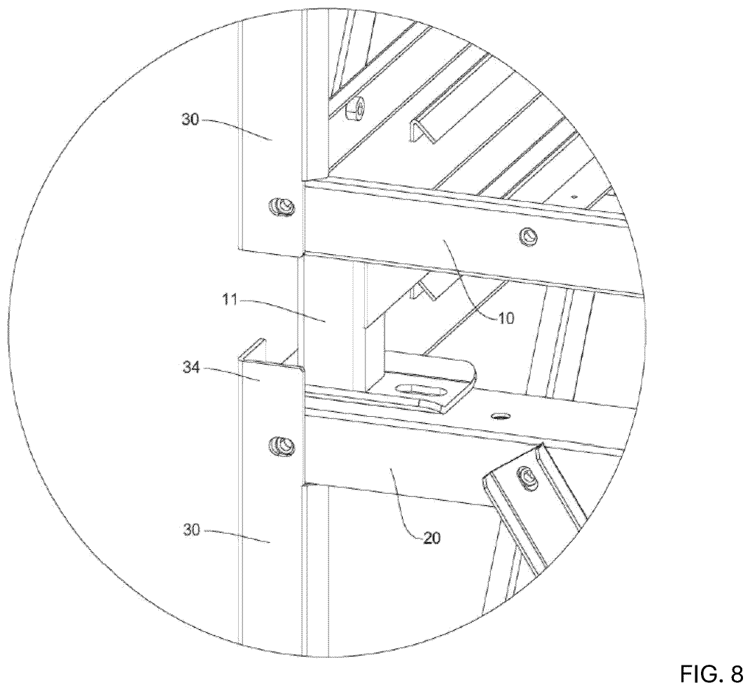

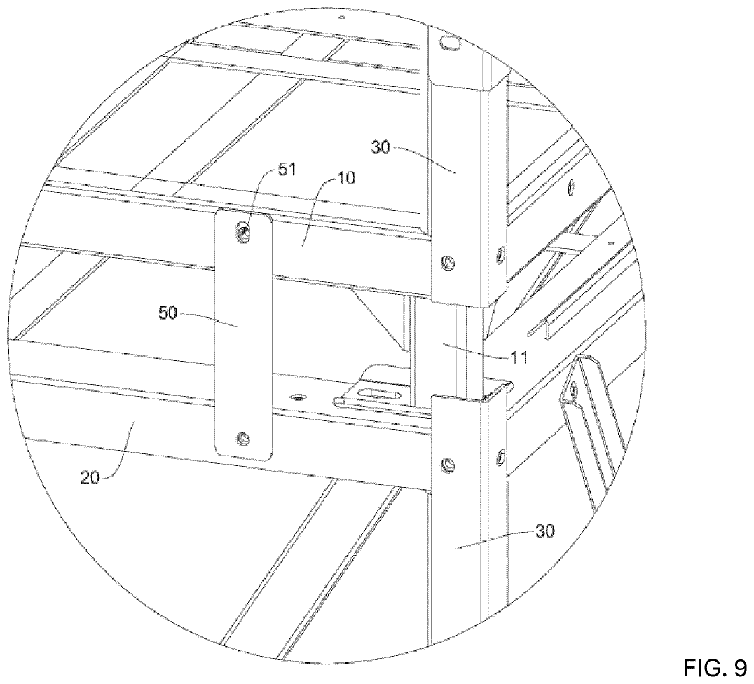

As shown in FIGS. 1 to 9, in an embodiment of the present invention, a generator packaging frame is provided, which includes a lower frame 10, an upper frame 20, a plurality of first support arms 30 and a plurality of second support arms 40. In this embodiment, the number of the first support arms 30 and the second support arms 40 is four, and when assembled, the four first support arms 30 or the four second support arms 40 are respectively located at four corners of the lower frame 10 and the upper frame 20. The lower frame 10 and the upper frame 20 are both rectangular frame structures, and the upper frame 20 is located above the lower frame 10. The first support arms 30 are detachably connected to the lower frame 10 and the upper frame 20, respectively. In addition, the second support arms 40 have a length smaller than that of the first support arms 30. Each second support arm 40 corresponds to one first support arm 30. The second support arms 40 are detachably arranged on the first support arms 30, and the second support arms 40 are detachably connected to the lower frame 10 and the upper frame 20, respectively.

When the first support arm 30 connects the lower frame 10 and the upper frame 20, the distance between the lower frame 10 and the upper frame 20 is denoted as L1. When the second support arm 40 connects the lower frame 10 and the upper frame 20, the distance between the lower frame 10 and the upper frame 20 is denoted as L2, and L2 is smaller than L1.

Referring to FIG. 1, in a first form of the packaging frame, four first support arms 30 are respectively connected to the lower frame 10 and the upper frame 20. At this time, the space between the lower frame 10 and the upper frame 20 is denoted as L1, and the volume in the packaging frame is the largest, so as to package and protect the generator, and facilitate transportation.

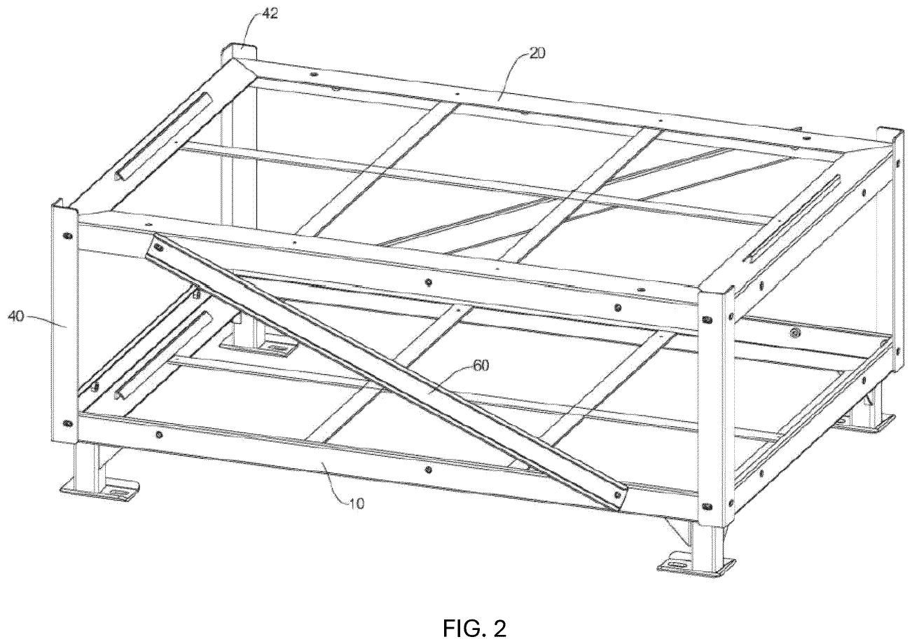

Referring to FIG. 2, in a second form of the packaging frame, four second supporting arms 40 are respectively connected to the lower frame 10 and the upper frame 20. At this time, a distance between the lower frame 10 and the upper frame 20 is denoted as L2, as can be seen from comparison between FIG. 1 and FIG. 2. The distance between the upper frame 20 and the lower frame 10 in the state of FIG. 2 is closer, and the packaging frame in this form can be used as a supporting seat of a generator for supporting the generator, so as to improve stability of the generator in the operation process.

According to the generator packaging frame disclosed by the embodiment, after the first supporting arm 30 is disassembled through the second supporting arm 40 with the shorter design length, the lower frame 10 and the upper frame 20 are connected through the second supporting arm 40, so that the whole height of the packaging frame can be reduced. In addition, the packaging frame can be used as a supporting seat to support a generator, thereby improving the stability of the generator in the running process. The packaging frame has two structural forms, can be used for packaging and transportation of the generator, can be used as a supporting seat of the generator after being reassembled, improves the stability of the generator in the operation process, avoids the waste of materials, and has the advantages of novel structure, various purposes and convenient disassembly and assembly.

In one embodiment, the first support arm 30 is provided with two first connection portions 31 in the vertical direction. The second support arm 40 is provided with two second connection portions 41 in the vertical direction, the lower frame 10 is provided with four third connection portions, and the upper frame 20 is provided with four fourth connection portions. Each first connection portion 31 includes two first mounting holes, each second connection portion 41 includes two second mounting holes, each third connection portion includes two third mounting holes, and each fourth connection portion includes two fourth mounting holes.

When the first support arm 30 is connected with the lower frame 10 and the upper frame 20, the first connection portion 31 is connected with the third connection portion and the fourth connection portion respectively. In addition, the first mounting holes are aligned with the corresponding third mounting holes and fourth mounting holes and are fastened by bolts.

When the second support arm 40 is coupled with the lower frame 10 and the upper frame 20, the second coupling portion 41 is coupled with the third coupling portion and the fourth coupling portion respectively. In addition, the second mounting holes are aligned with the corresponding third mounting holes and fourth mounting holes respectively and are fastened by bolts. The structural design not only can meet the strength requirement of the whole structure but also can achieve the purpose of quick assembly and disassembly.

In one embodiment, the first support arm 30 is provided with two fifth connecting portions 32 in the vertical direction, and the fifth connecting portions 32 are detachably connected with the second connecting portions 41. Each fifth connecting portion 32 includes a fifth mounting hole, and when the second support arm 40 is mounted to the first support arm 30, the second mounting hole can be aligned with the fifth mounting hole and can be fastened by bolts, thereby enabling the first connecting arm 60 to be quickly assembled and disassembled with the second connecting arm 60.

In one embodiment, the lower frame 10 is able to fitly stack on the top of the upper frame 20. The structure design enables two or more packing frames to be used in a stacked mode, so that space in the transport case can be fully utilized. The placing positions of the packing frames are standardized, and the packing frames are loaded as much as possible so that the transport cost is saved.

In one embodiment, when the first support arm 30 is connected to the upper frame 20, the first support arm 30 extends upward out of the top surface of the upper frame 20 and forms a first limiting portion 34. When two package shelves are stacked, under the restriction of four first limit parts 34, the package shelves above can be effectively limited, and the stability during stacking is ensured.

When the second support arm 40 is connected to the upper frame 20, the second support arm 40 extends upward out of the top surface of the upper frame 20 and forms a second limiting portion 42. In the same way, when the four second limiting parts 42 are used as supporting seats, the positions of the generators can be limited, so that the running stability of the generators on the packaging frame is ensured.

In one embodiment, the four corners of the lower frame 10 are respectively provided with supporting feet 11. The supporting feet 11 extend downward, and the supporting feet 11 may stack on the top surface of the upper frame 20. The design of the supporting legs 11 promotes the distance between the lower frame 10 and the ground and ensures that when two packaging frames are stacked, a sufficient gap is reserved between the upper frame 10 above and the upper frame 20 below, such that a forklift or hoisting equipment is convenient to transfer the packaging frames above.

In one embodiment, the upper frame 20 is provided with at least two connection blocks 50, and the connection blocks 50 are detachably connected to the upper frame 20. The connection block 50 is provided with a sixth connection portion 51, and the lower frame 10 is provided with a seventh connection portion that mates with the sixth connection portion 51. When two package frames are stacked, the connection blocks 50 are connected with the package frames above, such that the two package frames can be fastened and connected into a whole. Furthermore, the stability and safety of the package frames in a stacked state are ensured in the transportation process.

In one embodiment, the first support arm 30 is provided with a flange 33. The first support arm 30 and the second support arm 40 are made of angle steel. Two side edges of the first support arm 30 are respectively bent to form the flange 33. When the first support arm 30 is connected with the lower frame 10 and the upper frame 20, the flange 33 is respectively abutted against the upper frame 20 and the lower frame 10. The structural design of the flange 33 promotes the supporting effect on the upper frame 20, thereby promoting the supporting effect on the upper packing frame when stacking.

In one embodiment, the packaging frame further comprises four connecting arms 60, each connecting arm 60 being detachably connected to the upper frame 20 and the lower frame 10, respectively. The design of the connecting arm 60 can improve the overall structural strength of the packing frame and also make the safety of the packing frame higher.

In the description of the present invention, numerous specific details are set forth. However, it is understood that embodiments of the invention may be practiced without these specific details. In some instances, well-known methods, structures and techniques have not been shown in detail in order not to obscure an understanding of this description.

It should be noted that the above embodiments are only used to illustrate the technical solution of the present invention but not to limit the technical solution of the present invention. Additionally, although the detailed description of the present invention is given with reference to the above embodiments, it should be understood by those skilled in the art that the technical solution described in the above embodiments may be modified, or some or all technical features may be equivalently replaced. These modifications or substitutions do not make the essence of the corresponding technical solution deviate from the scope of the technical solution of the embodiments of the present invention, and all the modifications or substitutions are included in the scope of the claims and the specification of the present invention.

1. A generator packaging frame, comprising:
a lower frame;
an upper frame provided above the lower frame;
a plurality of first support arms, wherein the first support arms detachably connects the lower frame and the upper frame, respectively;
a plurality of the second support arms, wherein each second support arm corresponds to one first support arm, wherein the second support arms are detachably arranged on the first support arms, and wherein the second support arms can be detachably connected with the lower frame and the upper frame, respectively;
wherein the distance between the lower frame and the upper frame is denoted as L1 when the first support arm is connected with the lower frame and the upper frame, and the distance between the lower frame and the upper frame is denoted as L2 when the second support arm is connected with the lower frame and the upper frame; and
wherein L2 is smaller than L1.

2. The generator packaging frame according to claim 1, wherein the first support arm is provided with two first connection portions in the vertical direction, wherein the second support arm is provided with two second connection portions in the vertical direction, wherein the lower frame is provided with a plurality of third connection portions, and wherein upper frame is provided with a plurality of fourth connection portions; and
wherein the first connecting portion is detachably connected with the third connecting portion and the fourth connecting portion, respectively, and wherein the second connecting portion is detachably connected with the third connecting portion and the fourth connecting portion, respectively.

3. The generator packaging frame according to claim 2, wherein the first support arm is provided with two fifth connection portions in the vertical direction, and wherein fifth connection portions being removably connected to the second connection portions.

4. The generator packaging frame according to claim 2, wherein the lower frame is lapped over the upper frame.

5. The generator packaging frame according to claim 4, wherein the first support arm extends upwards out of the top surface of the upper frame and is formed with a first limit portion when the first support arm is connected to the upper frame; and
wherein the second supporting arm extends upwards out of the top surface of the upper frame and is provided with a second limiting part when the second supporting arm is connected with the upper frame.

6. The generator packaging frame according to claim 5, wherein the four corners of the lower frame are respectively provided with supporting feet, wherein the supporting feet extend downwards, and wherein the supporting feet can be lapped on the top surface of the upper frame.

7. The generator packaging frame according to claim 4, wherein the upper frame is provided with at least two connection blocks, wherein the connection blocks being provided with sixth connection portions, and wherein the lower frame being provided with seventh connection portions cooperating with the sixth connection portions.

8. The generator packaging frame according to claim 4, wherein the first support arm is provided with a flange, wherein the flange is located between two of the first connection portions, and wherein the flange is respectively abutted against the upper frame and the lower frame.

9. The generator packaging frame according to claim 3, wherein the lower frame is lapped over the upper frame.

10. The generator packaging frame according to claim 9, wherein the first support arm extends upwards out of the top surface of the upper frame and is formed with a first limiting part when the first support arm is connected to the upper frame; and
wherein the second supporting arm extends upwards out of the top surface of the upper frame and is provided with a second limiting part when the second supporting arm is connected with the upper frame.

11. The generator packaging frame according to claim 10, wherein the four corners of the lower frame are respectively provided with supporting feet, wherein the supporting feet extend downwards, and wherein the supporting feet can be lapped on the top surface of the upper frame.

12. The generator packaging frame according to claim 9, wherein the upper frame is provided with at least two connection blocks, wherein the connection blocks being provided with sixth connection portions, and wherein the lower frame being provided with seventh connection portions cooperating with the sixth connection portions.

13. The generator packaging frame according to claim 9, wherein the first support arm is provided with a flange, wherein the flange is located between two of the first connection portions, and wherein the flange is respectively abutted against the upper frame and the lower frame.

14. The generator packaging frame according to claim 1, further comprising a plurality of connection arms, wherein each of the connection arms is detachably connectable to the upper frame and the lower frame, respectively.
